(19) United States
(12) Patent Application Publication
(10) Pub. No.: US 2013/0236026 A1
(43) Pub. Date: Sep. 12, 2013

(54) CIRCUIT CAPABLE OF REDUCING AUDIO INTERFERENCE

(71) Applicant: FU-LI GAO, Shenzhen City (CN)

(72) Inventor: FU-LI GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/437,023

(22) Filed: Apr. 2, 2012

(30) Foreign Application Priority Data
Mar. 12, 2012 (CN) 201210063115.6

(51) Int. Cl. H04R 1/10

(52) U.S. Cl. 381/74

(57) ABSTRACT

A circuit capable of reducing audio interference includes an earphone output circuit. The earphone output circuit includes an earphone interface, a first inductance and a second inductance both connected to the earphone interface, a first capacitor, and another capacitor. The earphone interface includes an earphone detecting port, a right port, a left port, and a ground port. A first terminal of the capacitor is connected to the first inductance and the right port, and a first terminal of the another capacitor is connected to the second inductance and the left port.

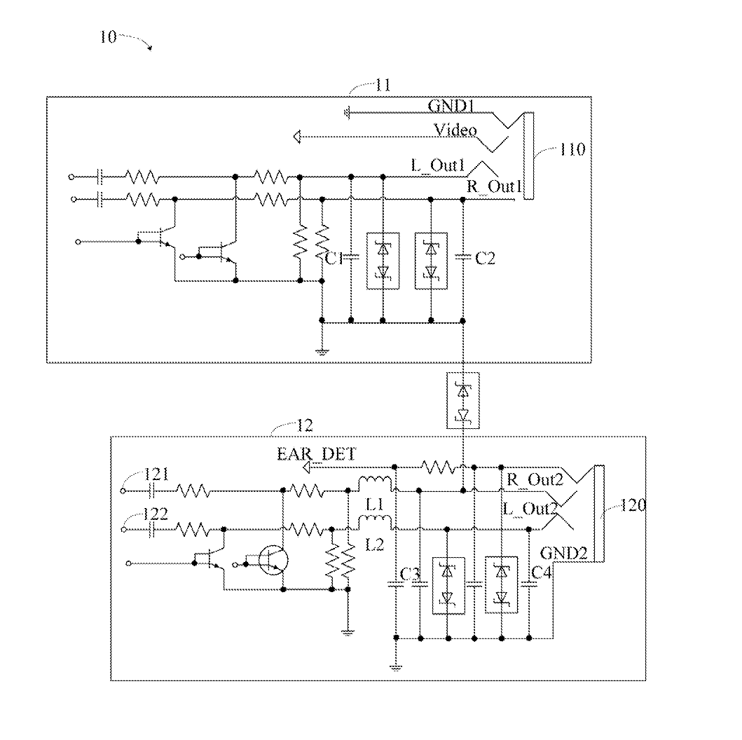

### BACKGROUND

1. Technical Field

The present disclosure relates to audio signal processing technology and, particularly, to a circuit capable of reducing audio interference.

2. Description of the Related Art

Audio interference affects the performance of electronic devices. A common mode inductor may be connected to an output port of a circuit of the electronic device to reduce the audio interference. However, the common mode inductor increases manufacturing cost of the electronic device.

### BRIEF DESCRIPTION OF THE DRAWING

The components in the drawings are not necessarily drawn to scale, the emphasis instead being placed upon clearly illustrating the principles of the disclosure. Moreover, in the drawing, like reference numerals designate corresponding parts throughout the several views.

The FIGURE is a circuit diagram of a circuit for reducing audio interference in accordance with an exemplary embodiment.

### DETAILED DESCRIPTION

Referring to the FIGURE, a circuit 10 capable of reducing audio interference is employed in a multimedia electronic device. The circuit 10 includes an audio output circuit 11 and an earphone output circuit 12. The audio output circuit 11 includes an audio interface 110 used to connect an electronic device (not shown), such as a sound generating device, for outputting audio signals to the electronic device. The earphone output circuit 12 includes an earphone interface 120 used to connect an earphone (not shown) for outputting audio signals to the earphone.

The audio output circuit 11 further includes a first capacitor C1 and a second capacitor C2. The audio interface 110 includes a right port R_Out1, a left port L_Out 1, and a ground port GND1. A first terminal of the first capacitor C1 is connected to the left port L_Out 1, and a second terminal of the first capacitor C1 is grounded. A first terminal of the second capacitor C2 is connected to the right port R_Out1, and a second terminal of the second capacitor C2 is grounded. The first capacitor C1 and the second capacitor C2 are configured to remove different types of well-known audio interference.

The earphone output circuit 12 includes a third capacitor C3, a fourth capacitor C4, a first inductance L1, and a second inductance L2. The earphone interface 120 includes an earphone detecting port EAR_DET, a right port R_Out2, a left port L_Out2, and a ground port GND2. A first terminal of the inductance L1 is connected to a first power input port 121, a second terminal of the inductance L1 and a first terminal of the third capacitor C3 are both connected to the right port R_Out2, and a second terminal of the third capacitor C3 is grounded. A first terminal of the first inductance L1 is connected to a second power input port 122, a second terminal of the first inductance L1 and a first terminal of the fourth capacitor C4 are both connected to the left port L_Out2, and a second terminal of the fourth capacitor C4 is grounded. The first inductance L1 and the third capacitor C3 are configured to remove audio interference, as are the second inductance L2 and the fourth capacitor C4.

In the embodiment, the audio output circuit 11 and the earphone output circuit 12 further include other elements which are used in audio output circuits and earphone output circuits of related art and will not be discussed here.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A circuit capable of reducing audio interference, comprising:
an earphone output circuit comprising:
an earphone interface comprising an earphone detecting port, a right port, a left port, and a ground port;
a first inductance connected to the earphone interface;
a second inductance connected to the earphone interface;
a capacitor with a first terminal connected to the first inductance and the right port; and
another capacitor with a first terminal connected to the second inductance and the left port.

2. The circuit capable of reducing audio interference as claimed in claim 1, wherein a second terminal of the capacitor and a second terminal of the another capacitor are grounded.
